(19) United States
(12) Patent Application Publication
(10) Pub. No.: US 2004/0135989 A1
(43) Pub. Date: Jul. 15, 2004

(54) Cloud sensor

(76) Inventor: Dimitri I. Klebe, Woodland Park, CO (US)

Correspondence Address: HANES & SCHUTZ, P.C., 102 S. TEJON ST., SUITE 800, COLORADO SPRINGS, CO, 80903, US

(21) Appl. No.: 10/339,451

(22) Filed: Jan. 9, 2003

(51) Int. Cl. G01J 3/457

(52) U.S. Cl. 356/3.06; 250/339.14

(57) ABSTRACT

A cloud imaging system monitors a condition of a portion of the sky. A lens defines a focal plane upon which the portion of the sky is directly mapped. An infrared sensor is disposed in the focal plane of the lens. The infrared sensor outputs data representative of the monitored portion of the sky. The data is interpreted to discover the condition of the monitored portion of the sky.

### FIELD OF THE INVENTION

This invention relates in general to a cloud cover sensor and, more particularly, to a sensor for discovering and monitoring cloud cover of a portion of the sky.

### BACKGROUND OF THE INVENTION

It is often desirable to discover the cloud cover for a portion of the sky. When there is adequate light, visual examination of the sky provides a rough indication of cloud cover. However, visual examination has many limitations. For instance, it does not provide an objective indication of the cloud cover. Additionally, many times it is desirable to discover the cloud cover for a portion of the sky that cannot be seen by the observer, for example, when the cloud cover of a remote location is desired to be known.

Conventional solutions for discovering cloud cover include remote cameras and infrared cloud cover detection systems. The cameras provide a visual indication of the cloud cover at remote locations, but still require adequate light to detect the cloud cover. Cameras also do not provide an objective indication of the cloud cover.

Many infrared cloud cover detection systems traditionally utilize expensive, very sensitive infrared detectors which must be temperature controlled at very low temperatures. Additionally, these infrared cloud cover detection systems are traditionally mirrored systems, which utilize either moving mirrors or dome mirrors to map an image of the sky to infrared sensors.

The moving mirror systems must have complex control systems, which add cost to the systems. In the dome mirror systems, the sensors are usually located directly above the center of the dome mirror. The sensors block a portion of the sky from being received and reflected by the dome mirror. The result is that a section of the sky, usually at the center of the portion analyzed by the detection system, cannot be evaluated.

### SUMMARY OF THE INVENTION

According to principles of the present invention, in one embodiment, a cloud imaging system monitors a condition of a portion of the sky. A lens defines a focal plane upon which the portion of the sky is directly mapped. An infrared sensor is disposed in the focal plane of the lens. The infrared sensor outputs data representative of the monitored portion of the sky. The data is interpreted to discover the condition of the monitored portion of the sky.

### DESCRIPTION OF THE DRAWINGS

FIG. 1 is a diagrammatical illustration of one embodiment of the present invention system for monitoring a condition of a portion of the sky.

### DETAILED DESCRIPTION OF THE INVENTION

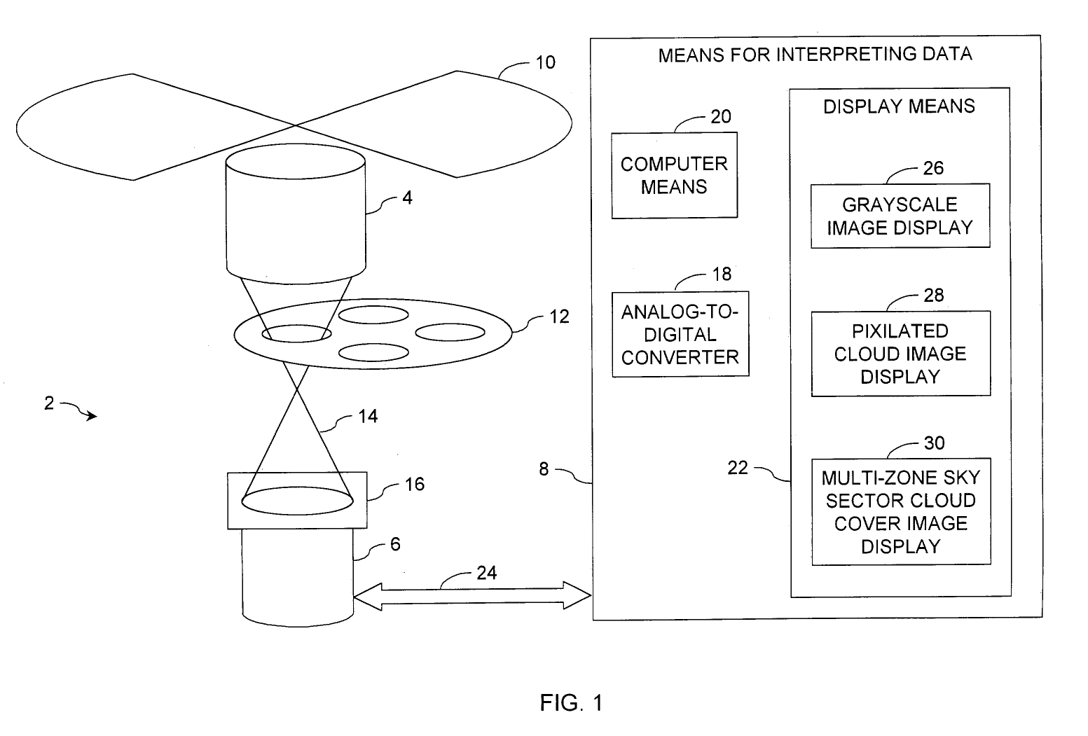

Illustrated in FIG. 1 is one embodiment of a system 2 for monitoring a condition of a portion of the sky. FIG. 1 is illustrative of the invention, it is not intended that the present invention conform to the shapes shown in FIG. 1. The system 2 includes a lens 4, an infrared sensor 6, and a means 8 for interpreting data from the sensor 6. The system 2 optionally includes a chopping wheel 10 and a filter wheel 12.

The lens 4 is any lens capable of passing infrared (IR) radiation 14 and focusing the IR radiation 14 on either the sensor 6 or a focal plane 16. In one embodiment, the lens 4 is a wide angle IR lens, such as a 150 degree, f/1.4 wide angle IR lens. Other lenses 4 may be used, as desired. Optionally, the lens 4 may be coated to improve its durability and reduce reflection.

The sensor 6 is any IR sensor capable of detecting the IR radiation 14 passed by the lens 4 and having an output of data representative of the monitored portion of the sky. In one embodiment, the sensor 6 is an uncooled 320×240 microbolometer array. The sensor 6 may be designed to operate over any desired frequency range. In one embodiment, the sensor 6 is designed to operate over the 7-14 micron spectral interval.

The means 8 for interpreting data is any combination of hardware and executable code (or instructions) adapted to interpret the data from the sensor 6. For example, the means 8 for interpreting data may include an analog-to-digital converter 18 and a computer means 20. The means 8 for interpreting data may also include a display means 22. Alternatively, the display means 22 may be separate from the means 8 for interpreting data, or may be omitted entirely from the system 2.

The means 8 for interpreting data communicates 24 either directly with the sensor 6 or indirectly through analog-to-digital converter 18. In one embodiment, the means 8 for interpreting data communicates 24 with the sensor 6 over an Ethernet.

The analog-to-digital converter 18 is any device adapted to receive analog data from the sensor 6 and produce an output of digital data representative of the monitored sky condition. The input of the analog-to-digital converter is connected to the output of the sensor 6. If the means 8 for interpreting data is able to interpret the data from the sensor 6 without an analog-to-digital converter 18, an analog-to-digital converter 18 may not be necessary.

The computer means 20 is any combination of hardware and executable code (or instructions) for performing sequences of stored instructions to process the data from either the sensor 6 or the analog-to-digital converter 18 to discover the condition of the monitored portion of the sky. The computer means 20 is connected to either the output of the sensor 6 or the output of the analog-to-digital converter 18, depending on whether an analog-to-digital converter 18 is used.

The display means 22 is any apparatus or system for displaying the sky condition being monitored. In one embodiment, the display means 22 comprises in operational series, a grayscale image display 26 of the sky, a pixilated cloud image display 28 of the sky, and a multi-zone sky sector cloud cover image display 30 of the sky.

The grayscale image display 26 provides a grayscale image of the sky as seen in the IR wavelengths. In one embodiment, the grayscale image display 26 of the sky is an image averaged over a period of time, such as a 15 second time interval or some other time interval. The image is processed and calibrated to indicate the brightness temperature as referenced to ground temperature. Ground temperature is the temperature of the ground or near the ground where the sensor 6 is located.

In one embodiment, the pixilated cloud image display 28 of the sky is a binary image having a variable threshold means for distinguishing between cloud and clear sky.

In one embodiment, the multi-zone sky sector cloud cover image display 30 of the sky comprises pixel counting means for labeling a given sector as cloudy, as a function of the percentage of pixels appearing within the given sector.

The chopping wheel 10 is any optical chopping wheel apparatus or assembly for periodically blocking the sky from the sensor 6. In one embodiment, the chopping wheel 10 is positioned between the lens 4 and the sky. Alternatively, the chopping wheel 10 is positioned between the lens 4 and the sensor 6.

The chopping wheel 10 provides automated background subtraction and improves flat-field calibration. In one embodiment, the chopping wheel 10 spins at a 5 Hz chopping rate. For absolute radiance calibration of the sensor 6, the temperature of the chopping wheel 10 must be know to a very high accuracy, such as better then one Kelvin. The chopping wheel 10 increases the sensitivity of the sensor 6 and improves the system's ability to delineate cloud structures, particularly cirrus clouds, and more accurately characterizes the sky's IR radiance. The improved sensitivity also allows the system to operate over narrower spectral bands, thus reducing interference from water vapor and ozone emissions.

The filter wheel 12 is any filter wheel apparatus or assembly for providing at least one IR filter between the lens 4 and the sensor 6. In one embodiment, the filter wheel 12 is a five-position filter wheel assembly. Other numbers of filters on filter wheel 12 may be used, as desired. For example, four filters are shown on the filter wheel 12 in FIG. 1.

In one embodiment, one of the filters of the filter wheel 12 is a 10.5-12.5 micron band pass filter. This filter is optimized to sense clouds and not water vapor, carbon dioxide, or ozone emissions. Other filters may be selected for use as calibration filters.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A cloud imaging system for monitoring a condition of a portion of the sky, the cloud imaging system comprising:
a lens defining a focal plane upon which the portion of the sky is directly mapped;
an infrared sensor disposed in the focal plane of the lens, the infrared sensor having an output of data representative of the monitored portion of the sky; and
means for interpreting the data to discover the condition of the monitored portion of the sky.

2. The system of claim 1 wherein the means for interpreting the data includes computer means for performing sequences of stored instructions to process the data to discover the condition of the monitored portion of the sky, the computer means connected to the output of the infrared sensor.

3. The system of claim 1 wherein the means for interpreting the data includes an analog-to-digital converter having an output of digital data representative of the monitored sky condition and having an input connected to the output of the infrared sensor.

4. The system of claim 3 wherein the means for interpreting the data includes computer means for performing sequences of stored instructions to process the data to discover the condition of the monitored portion of the sky, the computer means connected to the output of the analog-to-digital converter.

5. The system of claim 1 further including display means, connected to the means for interpreting the data, for displaying the sky condition being monitored.

6. The system of claim 5 wherein the display means comprises in operational series,
a grayscale image display of the sky,
a pixilated cloud image display of the sky, and
a multi-zone sky sector cloud cover image display of the sky.

7. The system of claim 6 wherein the grayscale image display of the sky is an image averaged over a period of time.

8. The system of claim 6 wherein the pixilated cloud image display of the sky is a binary image having a variable threshold means for distinguishing between cloud and clear sky.

9. The system of claim 6 wherein the multi-zone sky sector cloud cover image display of the sky comprises pixel counting means for labeling a given sector as cloudy, as a function of the percentage of pixels appearing within the given sector.

10. The system of claim 1 further including an optical chopping wheel between the lens and the sky.

11. The system of claim 10 wherein the chopping rate of the chopping wheel is greater than about one hertz.

12. The system of claim 1 wherein the sensor includes an array of bolometers.

13. The system of claim 12 wherein the bolometers are adapted to operate in about the 7-14 micron spectral interval.

14. The system of claim 1 further including an electromagnetic radiation band pass filter positioned between the lens and the infrared sensor to pass a selected spectral interval for analysis.

15. The system of claim 14 wherein the band pass filter comprises a plurality of modes for selectively passing narrower spectral intervals within a 7-14 micron spectral interval.

16. A cloud imaging system for monitoring a condition of a portion of the sky, the cloud imaging system comprising:
an infrared sensor having an output of data representative of the monitored portion of the sky;
a lens positioned and adapted directly map the portion of the sky to the infrared sensor; and
means for interpreting the data to discover the condition of the monitored portion of the sky.

17. The system of claim 16 wherein the means for interpreting the data includes computer means for performing sequences of stored instructions to process the data to discover the condition of the monitored portion of the sky, the computer means connected to the output of the infrared sensor.

18. The system of claim 16 wherein the means for interpreting the data includes an analog-to-digital converter having an output of digital data representative of the monitored sky condition and having an input connected to the outputs of the infrared sensor.

19. The system of claim 18 wherein the means for interpreting the data includes computer means for performing sequences of stored instructions to process the data to discover the condition of the monitored portion of the sky, the computer means connected to the output of the analog-to-digital converter.

20. The system of claim 16 further including display means, connected to the means for interpreting the data, for displaying the sky condition being monitored.

21. The system of claim 20 wherein the display means comprises in operational series,
a grayscale image display of the sky,
a pixilated cloud image display of the sky, and
a multi-zone sky sector cloud cover image display of the sky.

22. The system of claim 21 where the grayscale image display of the sky is an image averaged over a period of time.

23. The system of claim 21 where the pixilated cloud image display of the sky is a binary image having a variable threshold means for distinguishing between cloud and clear sky.

24. The system of claim 21 where the multi-zone sky sector cloud cover image display of the sky comprises pixel counting means for labeling a given sector as cloudy, as a function of the percentage of pixels appearing within the given sector.

25. The system of claim 16 further including an optical chopping wheel between the lens and the sky.

26. The system of claim 25 wherein the chopping rate of the chopping wheel is greater than about one hertz.

27. The system of claim 16 wherein the sensor includes an array of bolometers.

28. The system of claim 27 where the bolometers are adapted to operate in about the 7-14 micron spectral interval.

29. The system of claim 16 further including an electromagnetic radiation band pass filter positioned between the lens and the infrared sensor to pass a selected spectral interval for analysis.

30. The system of claim 29 wherein the band pass filter comprises a plurality of modes for selectively passing narrower spectral intervals within a 7-14 micron spectral interval.
